(19) United States
(12) Patent Application Publication
(10) Pub. No.: US 2025/0112252 A1
(43) Pub. Date: Apr. 3, 2025

(54) ALIGNED COOLANT AND REACTANT CHANNELS

(71) Applicant: ZeroAvia Ltd., Gloucestershire (GB)

(72) Inventor: Sergei SHUBENKOV, Gloucestershire (GB)

(73) Assignee: ZeroAvia Ltd., Gloucestershire (GB)

(21) Appl. No.: 18/480,257

(22) Filed: Oct. 3, 2023

(51) Int. Cl. H01M 8/0263; H01M 8/026; H01M 8/0297; H01M 8/1213

(52) U.S. Cl. CPC H01M 8/0263; H01M 8/026; H01M 8/0297; H01M 8/1213

(57) ABSTRACT

The invention of the current application is directed to A bipolar plate (BPP) including at least one serpentine reactant channel suitable for circulating a reactant and at least one coolant channel suitable for circulating a coolant. The at least one reactant channel and the at least one coolant channel are positioned parallel to each other and the BPP is a three-dimensional structure with six faces.

### BACKGROUND

While air-cooled High Temperature Proton Exchange Membrane (HTPEM) fuel cell systems are lighter-weight than traditional fluid-cooled versions, the thermal and physical properties of air result in less thermal flux i.e. high thermal conductivity, low thermal capacity, and low volumetric density. To account for the otherwise insufficient air flow, attempts have been made to optimize flow channel geometry of air-cooled bipolar plate (BPP), i.e., fewer number of channels per BPP that are deep and interconnected with each other. However, this comes at the cost of increased pressure drops along coolant flow, i.e., higher losses for cooling and/or increased overall stamping depth which does not allow to make reactant channels structure dense enough resulting in lower power density. Formation of deeper channels can also lead to significant mechanical issues, for example, cracking. Furthermore, achieving the same efficiency as fuel cells cooled with traditional fluid requires either higher power consumption or deep and short coolant channels, which ultimately limits fuel cell scaling and worsens the ratio of the active area to the whole fuel cell area which is important for achieving high specific power.

Applicants hereby incorporate by reference Portsmann, S., Wannemacher, T., Drossel W. G. A comprehensive comparison of state-of-the-art manufacturing methods for fuel cell bipolar plates including anticipated future industry trends. Journal of Manufacturing Processes, 60, 366-383 (2020). https://doi.org/10.1016/j.jmapro.2020.10.04. This text includes a comparison of state-of-the-art manufacturing methods for fuel cell bipolar plates including anticipated future industry trends Applicants hereby incorporate by reference Baek, S. M., Jeon, D. H., Nam, J. H. et al. Pressure drop and flow distribution characteristics of single and parallel serpentine flow fields for polymer electrolyte membrane fuel cells. J Mech Sci Technol 26, 2995-3006 (2012). https://doi.org/10.1007/s12206-012-0706-y. This text describes reactant channel multi-path serpentine patterns for optimized pressure and temperature distribution of Low Temperature Proton Exchange Membrane (LTPEM) but not for HTPEM, which have more stringent conditions. Furthermore, there is no integration of the reactant channels into the same layer as coolant (aligned) channels so the design is heavier and has more electrochemical losses.

Applicants hereby incorporate by reference U.S. Pat. No. 8,927,170. This reference concerns flow field plate for reduced pressure drop in coolant. It includes teachings regarding regulation of pressure distribution but teaches a less efficient offset duct geometry within the coolant channels rather than by inclines and hard stops leading into the reactant channels.

Applicants hereby incorporate by reference US 2005-0130003. This reference concerns cooling systems for a fuel cell stack. Its teachings relate to regulation of pressure through deflectors but for phase changing coolant in LT PEM rather than air coolant in HTPEM, so less light weight. It also teaches no integration into the same layer as reactant (aligned channels) so heavier and more electrochemical losses.

In view of the above, there is therefore a need to provide a novel flow field geometry for distributing cathode air to produce an aligned, dual-sided BPP with both coolant and reactant channels as one layer only separated by a foil. The current application also enables manufacture by cold stamping.

### SUMMARY OF THE INVENTION

The device of the current invention includes dual-sided BPPs which have been stamped, molded, or formed to have coolant channels aligned to reactant channels in one layer where the anodes and cathodes are separated by a membrane electrode assembly MEA. This structure allows for either a 20-50% decrease in BPP thickness compared to the prior art or a uniform pressure drop maintained across coolant and reactant channels by increasing the width, depending on the chosen embodiment and required power output.

The embodiments of the current application provide a single structure for both reactants and coolant, flowing parallel to each other, and can be made by cold stamping. Cold stamping is cheaper than other typical manufacturing methods, for example, hot pressing which is therefore advantageous when able to be used. In some embodiments, both types of channels are cold stamped into a single structure with two complementary sides, which is distinct from the traditional approach of hot-pressing separate layers.

In some embodiments a BPP can be made with a depth of from 0.4 mm to 0.95 mm, for example, 0.45 mm, 0.5 mm, 0.55 mm, 0.6 mm, 0.65 mm, 0.7 mm, 0.75 mm, 0.8 mm, or 0.85 mm. In a preferred embodiment the BPP is 0.8 mm deep. In some embodiments, both coolant and reactants are positioned in a single layer rather than the traditional method of hot stamping a BPP which is required to have at least a 0.95 mm total depth and made up of 2 types of channels: 0.45 mm for reactant channels and 0.5 for coolant channels. This limitation of the hot stamping method limits scaling possibilities.

In some embodiments, the total depth of a single aluminum BPP for HTPEM fuel cell, including the cathode channels plus coolant channels and anode channels, is from 1 mm to 1.9 mm. The total depth of stamping may be, for example, 1.1 mm, 1.15 mm, 1.2 mm, 1.25 mm, 1.3 mm, 1.35 mm, 1.4 mm, 1.45 mm, 1.5 mm, 1.55 mm, 1.6 mm, 1.65 mm, 1.7 mm, 1.75 mm, 1.8 mm, 1.85 mm, or 1.9 mm. In a preferred embodiment, aluminum BPP for the HTPEM fuel cell has a depth of stamping of 1.6 mm.

The embodiments of the current application have an overall thinner BPP and are also suitable for use in a 20 kW/stack application. A thinner BPP results in narrower channels and interchannel extrusions (lands) and thus provides a higher performance due to less mass transport losses. Mass transport is improved because narrow channels create concentration gradients that support lateral diffusion. Alignment of coolant and reactants channels allows to make them deeper and, therefore, longer which also improves fuel cell active area to passive area ratio, BPP scalability, and, therefore, increase of the stack specific power. Mechanical integrity is improved because thinner channels exert less stress and thus are less likely to crack than deeper channels. Scalability is improved due to no longer being as limited to coolant channels that are short relative to reactant channels, which enables higher BPP power output. Orientation of reactant channels along coolant flow allows to transfer additional heat from hotter areas of fuel cell to colder areas and, therefore, to minimize temperature gradients. The degree of these improvements depends on the ratio of BPP side lengths and channel dimensions.

More square shaped BPP provides new and enhanced flexibility in BPP sidelength ratios and thus channel dimensions is provided. A square shape was previously hard to achieve given the prior art 2-level-structured BPP where the coolant flowed perpendicular to reactants.

While a square-shaped BPP is the ideal for scaling-up fuel cell production, it was not achievable in the prior art because of tight restriction on the side length oriented along coolant flow which results in the traditional rectangular shape to achieve an operationally practical thermal gradient and coolant pressure drop. In some embodiments, the more square-shaped design including with the deep channels expands scalability by partially decoupling the cooling rate from the side length ratio.

A square-shaped BPP typically could not be used due to the thermal properties of air so the reactants had to flow along the long edge while the much shorter air coolant channels had to flow along the short edge. Some embodiments of the current application use semi-serpentine reactant channels coupled with vertical deflectors in the coolant channels, allowing for increased length of reactant channels and thus a more square-shaped, well-ventilated BPP that is more versatile and efficient in terms of the structuring the BoP to fit in the applications of interest, for example, in aerospace applications. In this application, vertical refers to the direction parallel to the direction of coolant flow. Further, regarding the square-shaped BPP, redirected reactant allows for less reactant inlet space (FIG. 3) and double-sided structure allows for thinner stacks

Some embodiments include incline-induced pressure gradient to optimize coolant flow in a multi-path serpentine flow field and thus provides improved GDL ventilation, as well as efficient heat transfer from hotter to less hot regions. Unlike traditional flow channels, the incline at the inlets and outlets enables the same differential pressure despite decreased air flow further from the inlets. In some embodiments the built-in inclines, parallel to the reactant supply, create differential pressure (AP) between the reactant's channels and as a result, efficiently push reactants over “lands” (interchannel extrusions) to the GDL. This improved GDL ventilation improves fuel cell performance because reactants can more effectively diffuse through the cell layers. The manufacturing method aligns channels and provides coolant channels that can be a more similar length to reactant channels and thus more square-shaped BPPs.

In some embodiments, the basic structure is scaled-up for higher power, for example, a 100 kW/stack application. In such embodiments, the same traditional BPP depth can be maintained but channels made deeper to allow for more flow of reactants. Channel alignment enables coolant channels that are a more similar or equal length as the reactant channels. Rectangular shaped BPP without channel alignment does not allow for this because it does not allow production of coolant channels as deep as the whole depth of stamping and, therefore, provide enough coolant channel throughput.

In some embodiments, the coolant channels include both vertical deflectors and extrusions formed from stamping the reactant channels. This works in parallel with a reactant channel, for example, multi-path serpentine pattern to evenly distribute heat and air flow. The multi-path serpentine pattern helps to redistribute heat and provide more uniform temperature distribution inside the fuel cell by means of reactant flow. The pattern is optimized for even pressure distribution given the new inclined gas-entry structure For example, in some embodiments using a square aluminum BPP with 13 cm side lengths (120 mm serpentine length and 5 mm from each incline), the vertical deflectors (channel branching) and serpentine structure can redistribute heat from the hot zones of the cell, for example, 190° C., to the less hot exit of each serpentine path, for example, 150° C. Inclines and hard stops may also be included where these structures can function to control the direction of gas flow and evenly distributing pressure.

The features of coolant channels serve to increase flow of coolant air for intensified heat rejection. The coolant passes as condensed flow when it is cold and distributes “wider” as it heats up. In some embodiments, vertical deflectors help deflect coolant from the main channels to the auxiliary ones. Vertical deflectors also may be understood as a kind of interchannel connection.

In some embodiments, the ratio of serpentine length to incline widths can vary depending on the required power output. In some embodiments, near the hard stops, stamping is slightly deeper to direct the gas flow into the serpentine. Hard stop position can be optimized for desired pressure gradient. Hard stops are sometimes used in bipolar plates to bear mechanical compression inside the stack and protect membrane-electrode assemblies (MEAs) from collapsing. In some embodiments, hard stops play additional role which is to provide boundaries for additional channels for reactants (anode hydrogen/cathode air) distribution. In some embodiments, coolant and reactants channels are aligned in the patterns where reactants and the coolant air flow vertically in the patterns while reactants distribution to and from are arranged in, for example, two horizontal channels. Hard stops act as the outer walls of these channels. The pressure drop along the channels is inevitable, although it is not created intentionally. In some embodiments, the shape of channels is triangular so that the pressure drop increases at a constant rate along the channels. This ensures equal flows for all patterns

In some embodiments, the reactant flow is designed to have channels parallel to the coolant channels and the air at the inlet travels perpendicular to the serpentine path entry point. Because of this structure, the flow rate and pressure naturally decrease as a portion of the air is split off into each serpentine. To correct for this, the incline gradually increases air pressure as the flow gets further from the inlet, resulting in equivalent pressure distribution—meaning an equal change in pressure between each serpentine path entry and exit along the width of the cell. For example, the change in pressure for the first serpentine path (250 kPa-245 kPa=5 kPa) would be the same as that of the last serpentine path (242 kPa-237 kPa=5 kPa).

The embodiments of the current application enables scaling to 50-150 kW stacks by enabling either wider and longer air-cooling fuel cell channels without increased BPP height and thus no stamping depth increase. They also enable air-cooling with lower coolant temperature and lower coolant density which is important for high-altitude operation.

The channel design of the embodiments of the current application enable flow in the same direction versus the traditional approach of coolant air and reactant gases perpendicularly flowing across the cell. This allows for more efficient cooling, as well as more space-efficient structuring of the Balance of Plant i.e., coolant and reactant gas tanks relative to inlet positions.

Aligned channels used in some embodiments, aid in air-cooling allow channels to be made deeper without increasing the thickness of BPP. The fuel cell can be wider change from a traditional rectangular shape to square shape which is important for fuel cell scaling.

Special channels along hard stops used in some embodiments, allow for the ability to supply reactants from gas ports/collectors which are positioned perpendicular to coolant flow direction and then redirect reactants to channels aligned with coolant channels. This enables channels alignment, without this it would be difficult to find a practical solution regarding how to bypass BPP active area and to deliver reactants to aligned channels.

In some embodiments the reactant's channels are arranged in a serpentine pattern. This aids in the transfer of heat from hotter parts of the cell to colder ones. High temperature gradients in a direction from coolant inlet to outlet is the drawback of air-cooling. When reactant channels are aligned with coolant channels, reactants can be supplied in counterflow to the coolant. A serpentine arrangement intensifies reactants recirculation and, therefore, heat flux reducing temperature gradient. This is relevant for high altitude aircrafts which are constantly operating in cold conditions of high altitudes which thereby provoke high temperature gradients.

In some embodiments, the serpentine design is only on the reactants side and coolant is not arranged in a serpentine pattern. In some embodiments, serpentine-shaped coolant channels would lead to too high pressure drops in the channels which is an issue when scaling fuel cells.

### BRIEF DESCRIPTION OF THE DRAWINGS

FIG. 1A depicts a cross-sectional view from the middle of a fuel cell stack showing the alignment of coolant and reactant channels when stacking multiple cells.

FIG. 1B depicts a cross sectional view from the outlet edge of a fuel cell stack showing the alignment of coolant and reactant channels when stacking multiple cells.

FIG. 1C is an isometric view showing possible positions of FIG. 1A and FIG. 1B relative to a fuel cell in three dimensions.

FIG. 2A is a prior art embodiment.

FIG. 2B is a comparison embodiment of the current application.

FIG. 2C is a stacked embodiment of the current application.

FIG. 3A shows a standard rectangular BPP stack.

FIG. 3B shows a thinner square BPP stack embodiment provided by the current application.

FIG. 3C shows a thicker square BPP stack embodiment provided by the current application.

FIG. 4 depicts the coolant face of the BPP including a zoomed in view of a coolant channel structure.

FIG. 5A depicts the reactant face of the BPP including a zoomed in view of a reactant channel structure FIG. 5B shows a representation of the distributive pressure incline and hard stop.

FIG. 6A shows the dimensions of a standard prior art multi-path semi-serpentine reactant channels.

FIG. 6B shows the relative dimensions of the thinner BPP multi-path semi-serpentine reactant channels.

FIG. 6C shows the relative dimensions of the thicker BPP multi-path semi-serpentine reactant channels.

### DETAILED DESCRIPTION OF THE DRAWINGS

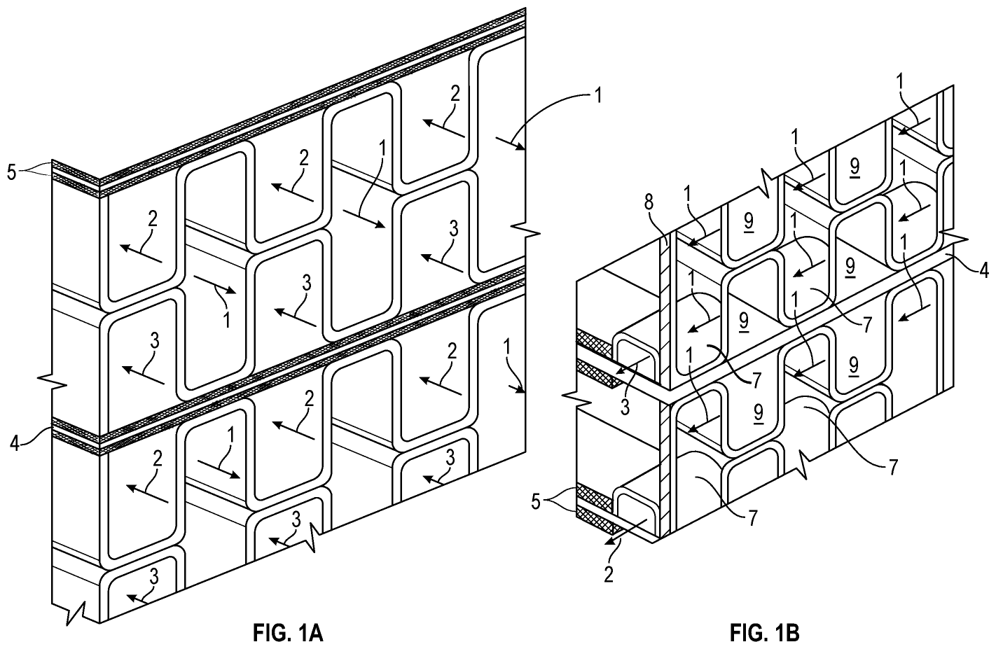

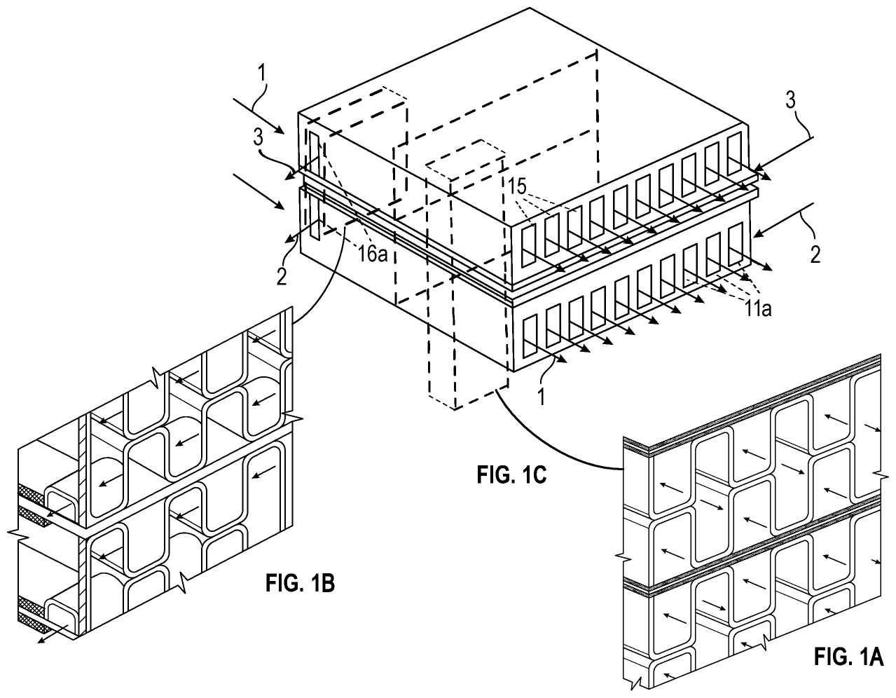

FIG. 1aA-B show cross sections of the alignment of the coolant and reactant flow fields when stacking multiple cells.

FIG. 1A is a front perspective view showing stacked cathode and anode cells as a cross section taken from the middle of a fuel cell stack. The structure of the cathode and anode cells are the same but include different reactants, and thus different suitable materials are used for these different parts. Coolant 1 flows antiparallel (parallel but in the opposite direction) to anode hydrogen 2 and cathode air 3. The cells are arranged so that the channels with anode hydrogen 2 are separated from those with cathode air 3 by a membrane 4 surrounded by two gas diffusion layers GDL 5 to compose the membrane electrode assembly MEA which is the active area in the fuel cell reactions.

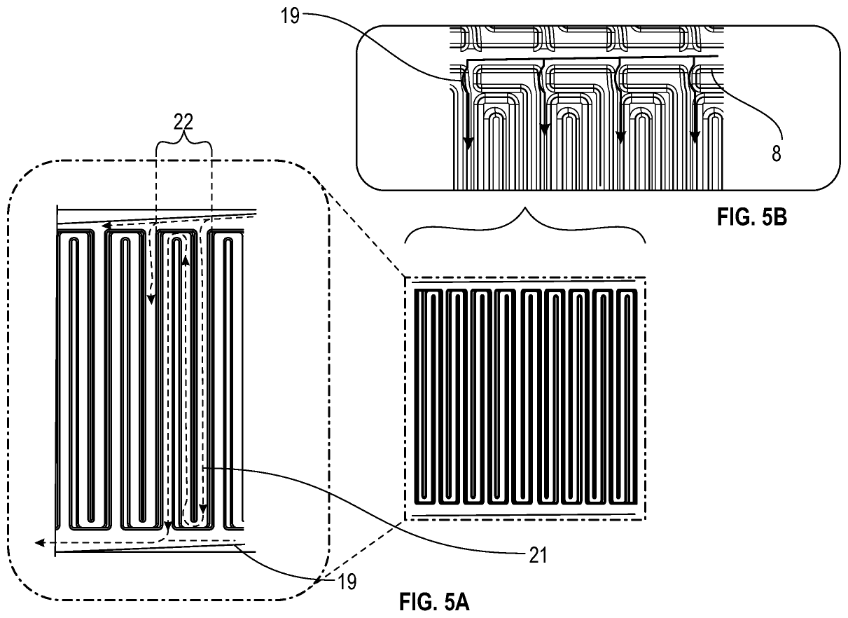

FIG. 1B is a front perspective view showing stacked cathode and anode cells as a cross section taken from the outlet edge of a fuel cell stack. In contrast with FIG. 1A, there are visible outlet channels 7, where the anode hydrogen 2 and cathode air 3 reactants enter the fuel cell. The reactant channels in this edge part of the cell are separated by only a membrane 4 and thus make up a passive area which is offset from the active area. This allows for more reactant gas to pass than the active area which includes the GDLs 5, thicker than the membrane alone, to form a membrane electrode assembly (MEA) as in FIG. 1A. Hard stops 8 are shown at the outer edge of each cell, functioning as boundaries and support for mechanical compression. In this view, the coolant 1 now flows parallel to the anode hydrogen 2 and cathode air 3 due to the position of the cross section, specifically in regards to the position of the outlet channel 7 relative to the vertical deflectors 17 of the coolant, not shown in this view-see FIG. 4, 1 and the serpentine path 16 of the anode hydrogen 2 and cathode air 3, as not shown in this view, see FIG. 5. This view includes closed areas 9 where there is no flow due to the path of the serpentine and the particular foil stamping pattern in this embodiment.

FIG. 1C is an isometric perspective of a potential fuel cell embodiment showing the relative positions of the cross-sectional views from FIG. 1A and FIG. 1B. FIG. 1A, a cross section taken from the middle of a fuel cell stack, is shown to extend below the visible stack to include a second MEA layer and the continued pattern of channels. FIG. 1B, a cross section taken from the outlet edge of a fuel cell stack, is shown to extend below the visible stack to include the approximate positioning of a second inlet and a second MEA layer.

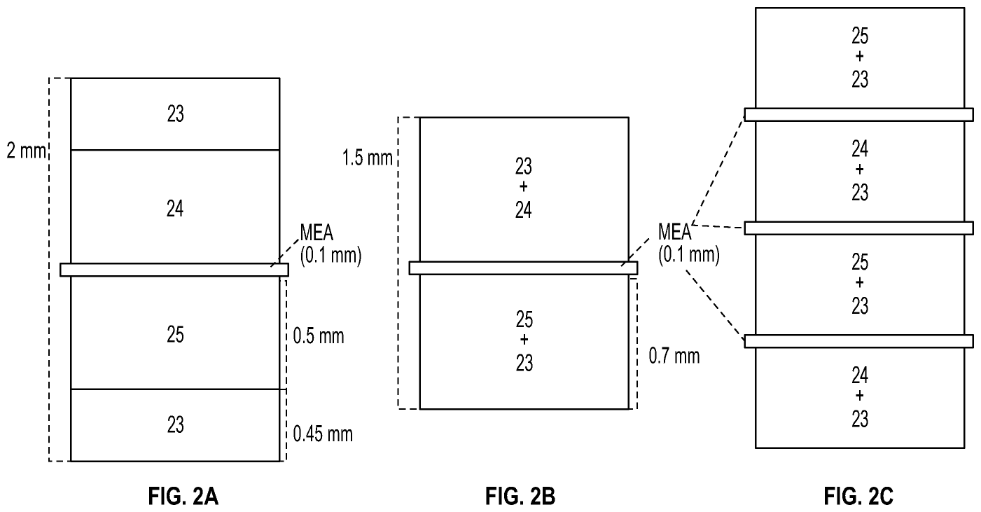

FIG. 2A is a prior art embodiment. The prior art BPP separates the coolant structures 23 from the cathode reactant structures 24 and anode reactant structures 25 by the excess BPP material resulting from traditional manufacturing where the channels are not aligned. This is because these structures had to be to be separately stamped or formed into the BPP.

FIG. 2B shows an example embodiment of the current application in comparison to a similar cell depicted in FIG. 2A. The embodiments of the current application instead utilize a single two-sided layer of BPP which allows for the coolant structures 23 and cathode reactant structures 24 to be joined as well as coolant structures 23 and anode reactant structures 25 to be joined. The separation in the prior art embodiments result in a larger overall structure whereby the combining of coolant and cathode and anode reactant structures 24 and 25, in the example shown, saves 0.25 mm of space per cell in comparison to the prior art arrangement.

FIG. 2C shows a stacked embodiment of the current application having multiple cells which are depicted in FIG. 2B. The coolant 23 and reactant structures 24 and 25 are repeated in a stack configuration with a MEA separating the coolant 23 plus anode structure 25 combination from the coolant 23 plus cathode structure 24 combination. With every stack, the space saved is multiplied over the prior art thereby saving the same percentage of space at any scale. Using the prior art design, one must stamp two levels of crossing channels, i.e., one level for reactants and the second for coolant air. In the embodiments herein, all channels can be on one layer. Coolant and reactants may pass on the opposite sides of foil sheet. In some embodiments channels are stamped in a foil sheet and reactant's channels are located on one side of the sheet while coolant channels are located on the other side. When shaping channels and ‘hills’ on one side one also simultaneously creates ‘hills and channels on the opposite side.

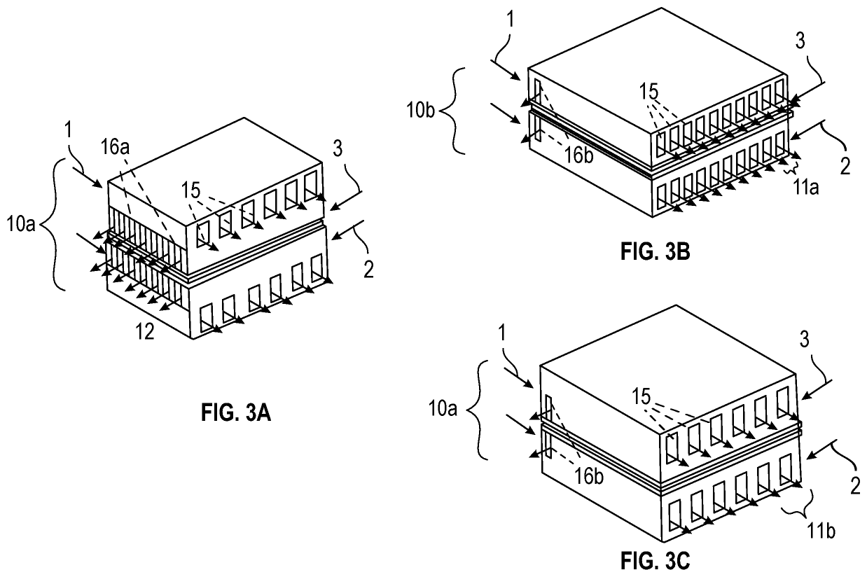

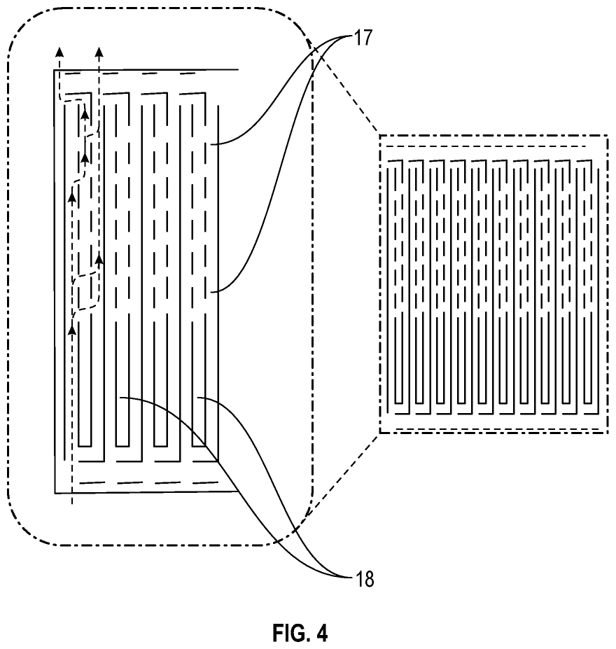

FIG. 3A shows a standard prior art rectangular BPP stack. The BPP prior art thickness 10a is not as thin as embodiments that are able to be achieved in the current application since a separate area must be provided for reactant gas and coolant media requiring greater overall space which is consistent with FIG. 2A. The coolant channels in these embodiments are shallow and short which are shown by the coolant outlet 15 configuration. The inlets (not visible in this view but would be adjacent to the inflowing reactant, namely the anode hydrogen 2 and cathode air 3) and outlets 16a both consist of a multitude 12 of small entry/exit points but on opposite sides. Additionally, FIG. 3A shows from the orientation of the inflowing reactant 3 and 2 and the outflowing reactant 12 as compared to the inflowing coolant 1 and coolant outlets 15, that the coolant channels and reactant channels inside the structure do not run parallel to each other. This is at least because the relative inlets and outlets are not positioned on the same face of the BPP.

FIG. 3B shows a thinner, square BPP embodiment with thickness 10b provided by the current application. The stamping method for channel alignment enables coolant channels that are a more similar or equal length as the reactant channels. In the thinner BPP 10 embodiments, both the coolant channels 11a and reactant channels 16b are narrower and longer as compared to the standard embodiments depicted in FIG. 3A. In FIG. 3B, the coolant outlet 15 and reactant outlet 16b are positioned on the same layer of the BPP. The inlets (not visible in this view but would be adjacent to the inflowing reactant, namely the anode hydrogen 2 and cathode air 3) and outlets 16a both consist of a single small entry/exit points but on opposite sides. This configuration is consistent with the redirecting of reactant flow illustrated in FIG. 5A.

FIG. 3C shows a thicker square BPP stack embodiment provided by the current application. In the thicker BPP embodiments, both the coolant channels 15 and reactant channels (visible as the reactant outlet 16b is this figure) are deeper and longer as compared to the standard embodiments depicted in FIG. 3a. As in FIG. 3B, the stamping method for channel alignment enables coolant channels that are a more similar or equal length as the reactant channels.

FIG. 4 shows the coolant face of the BPP including a zoomed in view of a coolant channel structure. The arrows show the direction of coolant flow through the system. Closed areas 9, not shown in this view, see FIG. 1B, include vertical air flow deflectors 17 and extrusions 18 formed from stamping the reactant channel. These structures combine to form a serpentine multi-path for the coolant media to flow through while traveling from the coolant inlet to the coolant outlet 15.

FIG. 5A shows the reactant face of the BPP including a zoomed in view of a reactant channel structure. The reactant flows from reactant inlet to reactant outlet 16b, not shown in this view-see FIG. 3B-C, through one of multiple serpentine channels 21 in the same flow direction as the coolant media. The cathode air 3 and anode hydrogen 2 do not flow in the same channels but follow the same flow path. Only one kind of reactant flows through each layer of reactant channels (see FIG. 1-3). The distributive pressure incline 19 is formed by hard stops 8 that run parallel to the reactant inlet and reactant outlet 16b and decrease the width of the reactant channel as the distributive pressure incline moves away from the reactant inlet and increases in width as the distributive pressure incline 19 moves toward the reactant outlet 16b. It can be seen that the serpentine channels 21 are oriented 90 degrees from the inlet and outlet 16, and thus the reactant flow path 21 through the serpentine channels 22 is parallel to the coolant channels shown in FIG. 4 which are oriented in line with their respective inlet and outlet 15 but where the coolant inlet and coolant outlet 15 are oriented 90 degrees from the reactant inlet and reactant outlet 16b.

FIG. 5B show a representation of the distributive pressure incline 19. Unlike traditional flow channels, the inclination at the inlets and outlets formed by the distributive pressure incline 19 enables the same differential pressure despite decreased air flow further from the inlets. As shown in FIG. 5B, the built-in inclines formed by hard stops 8 run parallel to the reactant inlet and outlet and decrease in width as they move away from the inlet and increase in width as they move toward the outlet. This creates differential pressure (AP) between the reactant's channels and as a result, efficiently pushes reactants over all of the multiple semi-serpentine channels.

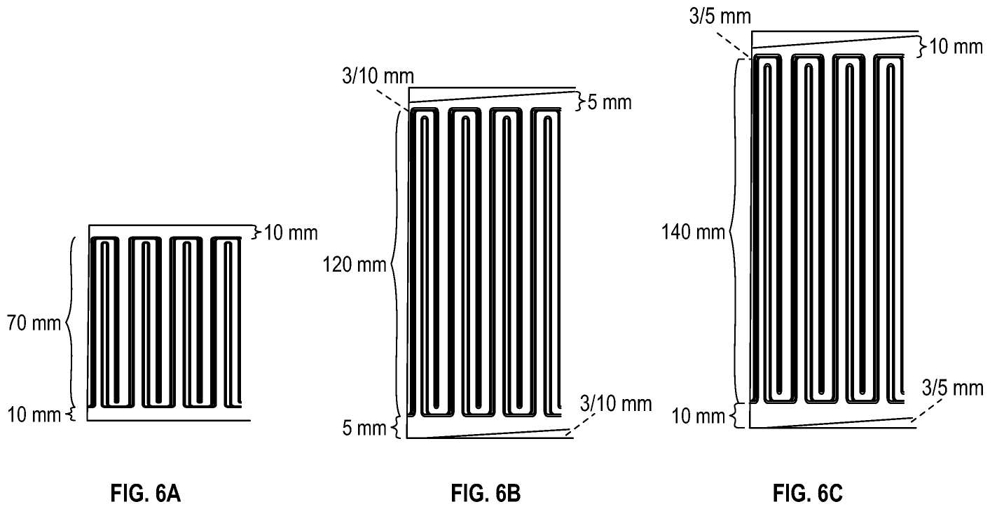

FIG. 6A shows the dimensions of a standard prior art multi-path semi-serpentine reactant channels. The specific measurements can be compared relatively between FIGS. 6a-c.

FIG. 6B shows the relative dimensions of the thinner BPP multi-path semi-serpentine reactant channels.

FIG. 6C shows the relative dimensions of the thicker BPP multi-path semi-serpentine reactant channels.

1. A bipolar plate (BPP) comprising:
at least one serpentine reactant channel suitable for circulating a reactant; and
at least one coolant channel suitable for circulating a coolant,
wherein the at least one reactant channel and the at least one coolant channel are positioned parallel to each other, and
wherein the BPP is a three-dimensional structure with six faces.

2. The bipolar plate of claim 1 additionally comprising:
a reactant inlet;
a reactant outlet;
a coolant inlet; and
a coolant outlet,
wherein the reactant inlet and coolant inlet are positioned on adjacent faces of the BPP and oriented 90 degrees from each other.

3. The bipolar plate of claim 1 wherein the BPP is a cube.

4. The bipolar plate of claim 2 wherein the BPP is a cube.

5. The bipolar plate of claim 1 wherein the at least one serpentine reactant channel and the at least one coolant channel are positioned on the same level with the BPP from which they are stamped being the only physical separation between them.

6. The bipolar plate of claim 1 wherein the at least one serpentine reactant channel and the at least one coolant channel are the same length in active area.

7. The bipolar plate of claim 1 wherein the at least one coolant channel comprises at least one air flow deflector.

8. The bipolar plate of claim 1 wherein the at least one serpentine reactant channel comprises a distributive pressure incline.

9. The bipolar plate of claim 8 wherein the distributive pressure incline is formed by hard stops which run parallel to the reactant inlet and reactant outlet and decreases the width of the reactant channel as the distributive pressure incline moves away from the reactant inlet and increases in width as the distributive pressure incline moves toward the reactant outlet.

10. The bipolar plate of claim 2 wherein the serpentine reactant channels are oriented 90 degrees from the reactant intel and the reactant outlet and wherein the reactant serpentine channels flow in parallel direction to the coolant channels and wherein the coolant channels are oriented in line with the coolant inlet and coolant outlet.

11. The bipolar plate of claim 1 wherein the at least one serpentine reactant channel and the at least one coolant channel have a combined depth of from 0.4 mm to 0.95 mm.

12. The bipolar plate of claim 11 wherein the at least one serpentine reactant channel and the at least one coolant channel have a combined depth of from 0.65 mm to 0.8 mm.

13. The bipolar plate of claim 11 wherein the at least one serpentine reactant channel and the at least one coolant channel have a combined depth of 0.8 mm.

14. An HTPEM fuel cell in a stack comprising one bipolar plate of claim 1 wherein said bipolar plate is separated by a membrane electrode assembly (MEA) wherein the reactant in the bipolar plate is either a cathode reactant or anode reactant. The MEA is surrounded by two bipolar plates where one of the plates is part of the adjacent fuel cell.

15. An HTPEM fuel cell stack wherein the cathode and anode cells are separated by only a membrane in the passive inclined area allowing for more reactant gas to pass while in the active area, the membrane is between gas diffusion layers (GDLs), forming a thicker (˜5 um) membrane electrode assembly (MEA).
